(19) United States
(12) Patent Application Publication
(10) Pub. No.: US 2008/0036758 A1
(43) Pub. Date: Feb. 14, 2008

(54) SYSTEMS AND METHODS FOR DETERMINING A GLOBAL OR LOCAL POSITION OF A POINT OF INTEREST WITHIN A SCENE USING A THREE-DIMENSIONAL MODEL OF THE SCENE

(75) Inventors: David O. Carpenter, Kearns, UT (US); Stanley E. Coleby, Holladay, UT (US); James U. Jensen, Salt Lake City, UT (US); Gary L. Robinson, Sandy, UT (US); Robert M. Vashisth, Salt Lake City, UT (US)

Correspondence Address: MADSON & AUSTIN, 15 WEST SOUTH TEMPLE, SUITE 900, SALT LAKE CITY, UT, 84101, US

(73) Assignee: InteliSum Inc., Salt Lake City, UT (US)

(21) Appl. No.: 11/694,926

(22) Filed: Mar. 30, 2007

Related U.S. Application Data
(60) Provisional application No. 60/788,422, filed on Mar. 31, 2006.
(60) Provisional application No. 60/747,852, filed on May 22, 2006.
(60) Provisional application No. 60/788,416, filed on Mar. 31, 2006.
(60) Provisional application No. 60/827,596, filed on Sep. 29, 2006.
(60) Provisional application No. 60/827,624, filed on Sep. 29, 2006.

(51) Int. Cl. G06T 15/00

(52) U.S. Cl. 345/419

(57) ABSTRACT

A three-dimensional image is generated using global or local coordinate, 3-D spatial data, and image data gathered from one or more locations relative to a scene. The global or local position of 3-D spatial data points on the image is determined. The position of a point of interest on the three-dimensional image is determined by creating a three-dimensional polygon using adjacent 3-D spatial data points. The global or local position of these points may then be calculated using, for example, a ray tracing algorithm. The global or local position of a point of interest may alternatively be approximated, for example, by interpolating the global or local coordinates of the 3-D spatial data point(s) closest to the point of interest. Furthermore, a distance, bearing, or other measurement between two points of interest may also be calculated.

### RELATED APPLICATIONS

This application claims the benefit of and priority to U.S. Provisional Patent Application Ser. No. 60/788,422 filed on Mar. 31, 2006 entitled “Systems and Methods for Determining a Global Position of a Point of Interest within a Scene Using LIDAR and GPS Data,” with inventors David O. Carpenter, Stanley E. Coleby, James U. Jensen, Gary L. Robinson, and Robert M. Vashisth; U.S. Provisional Patent Application Ser. No. 60/788,416 filed on Mar. 31, 2006 entitled “Systems and Methods for Determining a Global Position of a Point of Interest within a Scene Using a Three-Dimensional Image of the Scene” with inventors David O. Carpenter, Stanley E. Coleby, James U. Jensen, Gary L. Robinson, and Robert M. Vashisth; U.S. Provisional Patent Application Ser. No. 60/747,852 filed on May 22, 2006 entitled “Systems and Methods for Determining a Global Position of a Point of Interest within a Scene Using a Three-Dimensional Image of the Scene,” with inventors David O. Carpenter, Stanley E. Coleby, James U. Jensen, Gary L. Robinson, and Robert M. Vashisth; U.S. Provisional Patent Application Ser. No. 60/827,596 filed on Sep. 29, 2006 entitled “Systems and Methods for Collecting Accurate Geographic Coordinate Data for Scenes Using Targets at Independently Determined GPS Locations,” with inventors David O. Carpenter, Stanley E. Coleby, James U. Jensen, Gary L. Robinson, Robert M. Vashisth, Edwin T. Allred and Brandon J. Baker; and U.S. Provisional Patent Application Ser. No. 60/827,624 filed on Sep. 29, 2006 entitled “Systems and Methods for Collecting Accurate Geographic Coordinate Data for Scenes Using Attribute Encoded Targets at Independently Determined GPS Locations,” with inventors David O. Carpenter, Stanley E. Coleby, James U. Jensen, Gary L. Robinson, Robert M. Vashisth, Edwin T. Allred and Brandon J. Baker. All of the above-listed applications are expressly incorporated by reference into this application.

### TECHNICAL FIELD

The present invention relates generally to three-dimensional imaging systems. More specifically, the present invention relates to systems and methods for determining the global or local coordinates of a point of interest on a three-dimensional image of an indoor or outdoor scene.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram of one embodiment of a system for gathering global positioning system (GPS) data, photographic pixel data, and 3-D spatial data for a scene;

FIG. 2A is a block diagram of one embodiment of a computer system displaying a two-dimensional image representing a three-dimensional image of a scene;

FIG. 2B is a close-up view of a portion of the image depicted in FIG. 2A;

FIG. 3 is a flow diagram illustrating one embodiment of a method for determining the global or local coordinates of a point of interest on a three-dimensional image;

FIG. 4 is a flow diagram illustrating one embodiment of a method of determining a bearing, slope, distance, or other measurement between two points of interest on a three-dimensional image; and

FIG. 5 is a block diagram illustrating the major hardware components typically utilized in a computer system that may be utilized in connection with or as part of the disclosed invention.

### DETAILED DESCRIPTION

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

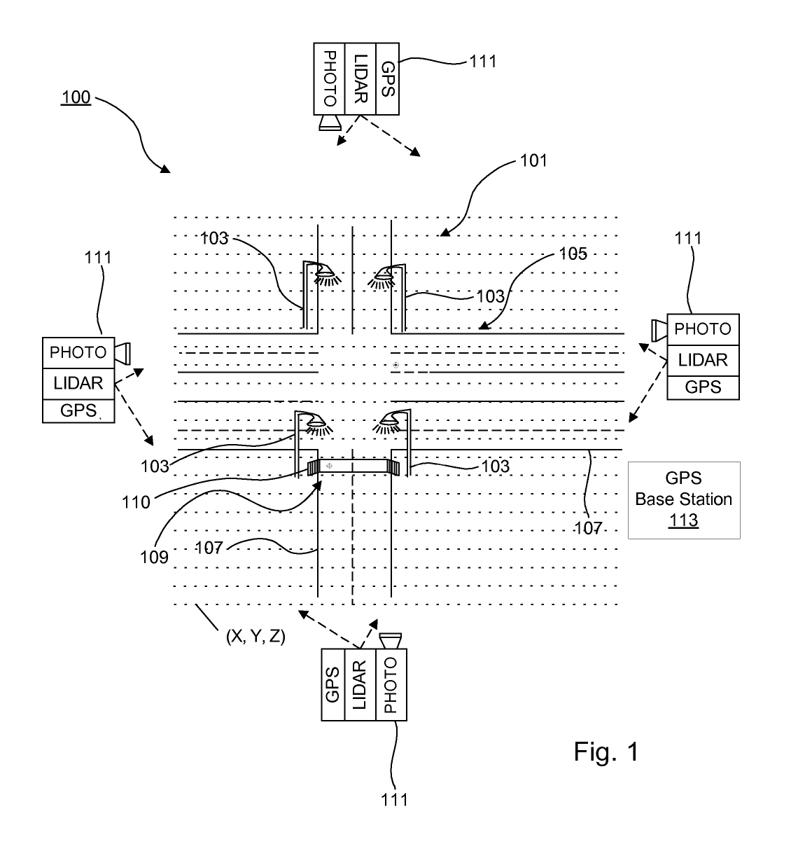

FIG. 1 is a block diagram illustrating one embodiment of a system 100 that gathers at least three separate types of data for a scene 101: photographic image data, which may be embodied as red, green, and blue (RGB) data, or black and white image data; 3-D spatial data (e.g., light detection and ranging (LIDAR) data), which is sometimes called X, Y, and Z dimensional (XYZ) data; and global or local coordinate data. Image data may be gathered by a digital camera.

The depicted scene 101, illustrating one embodiment, includes four street lights 103, an intersection 105 of two streets 107, and a painted symbol 109 on one of the streets 107. The painted symbol 109 is obscured by a bridge 110. Because of the bridge 110, GPS signals are not receivable at the painted symbol 109. As a result, the GPS coordinates of the painted symbol 109 are not directly obtainable because this obstruction interferes with signals from orbiting GPS satellites. Of course, other types of obstructions (such as buildings and trees) may impede the reception of GPS signals. The scene 101 is shown in two-dimensions in FIG. 1 and, as such, this flat surface scene is representative of a three-dimensional scene. The present invention also includes the ability to determine the global or local coordinate position of virtually any object or point in the scene for which there is image data although there may not be 3D spatial data gathered for the point or object.

Four data gathering devices 111 are positioned at four locations around the scene 101. In an alternative embodiment, a single data gathering device 111 (or any other number of data gathering devices 111) may be utilized to gather data from multiple positions relative to the scene 101. As shown in FIG. 1, each depicted data gathering device 111 obtains image data, 3-D spatial data, global or local coordinate data, and optionally other types of data. The data gathering device(s) 111 shown in FIG. 1 are merely exemplary and not limiting of the disclosed systems and methods. For example, each of the data gathering device(s) 111 depicted in FIG. 1 is an integrated or unified device that gathers image data, 3-D spatial data, and global or local coordinate data. Alternatively, however, two or three separate devices may be used to gather the pixel, 3-D spatial data, and global or local coordinate data, respectively. In addition, the number of data gathering device(s) 111 may vary depending on circumstances and the purpose for which the data is gathered. In an alternative embodiment, a fish eye lens, rather than a conventional photographic lens, is used to gather image data (i.e., digital photographic data). The data gathering device(s) 111 may be stationary, moving, or even airborne (e.g., positioned on a helicopter or airplane).

The GPS data may be obtained using a wide variety of techniques, such as differential GPS (DGPS) or standard, non-differential GPS. DGPS uses a stationary GPS receiver (often referred to as a GPS base station 113) and a mobile GPS receiver. The base station 113 is at a known global position. The base station 113 gathers GPS data and compares the gathered GPS data to the actual location of the base station 113. Corrective data is generated based on the difference between the gathered GPS data and the actual global position of the base station 113. This corrective data is used to correct GPS readings obtained by the mobile GPS receiver. The corrective data may be transmitted or broadcast by the base station 113 in real time to the mobile GPS receiver, which is often referred to as a real time kinematic (RTK) procedure. In some embodiments, the differential, or corrective, data may be obtained through a subscription service from a third-party.

Global coordinate data for the gathering device(s) 111 (i.e., the global position of the device(s) 111) may be gathered or determined in other ways beyond the use of GPS data gathering devices. For example, a total station, which is an optical instrument used in modern surveying, may be utilized to determine the global position of the data gathering device(s) 111 by reference to a point of a known global or local position, such as a surveying monument. As another example, a data gathering device 111 could be positioned on top of or near a surveying monument of a known global position to determine its global or local position. Alternately, a global or local position of virtually any object could be determined or known and thus could be used as a reference point to determine the position of a data gathering device 111 or the position of the data gathered by the data gathering device(s) 111.

The image data are a series of digital pixels that provide a visual image of the scene 101. The gathered 3-D spatial data comprises three-dimensional distance (e.g., an X, Y, and Z component or a distance plus horizontal and vertical angles in polar coordinates or other coordinate information) information for points within the scene 101. More specifically, the data comprises a three-dimensional distance between the data gathering device 111 and a specified point in the scene 101. The global or local position data identifies the global or local position of the data gathering device 111. Global or local position data may also be directly gathered for certain points within the scene 101 to provide position information for these points. Systems and methods for gathering global or local position data, image data, and 3-D spatial data are disclosed in U.S. Pat. No. 6,759,979 to Vashisth et al., which is incorporated by this reference.

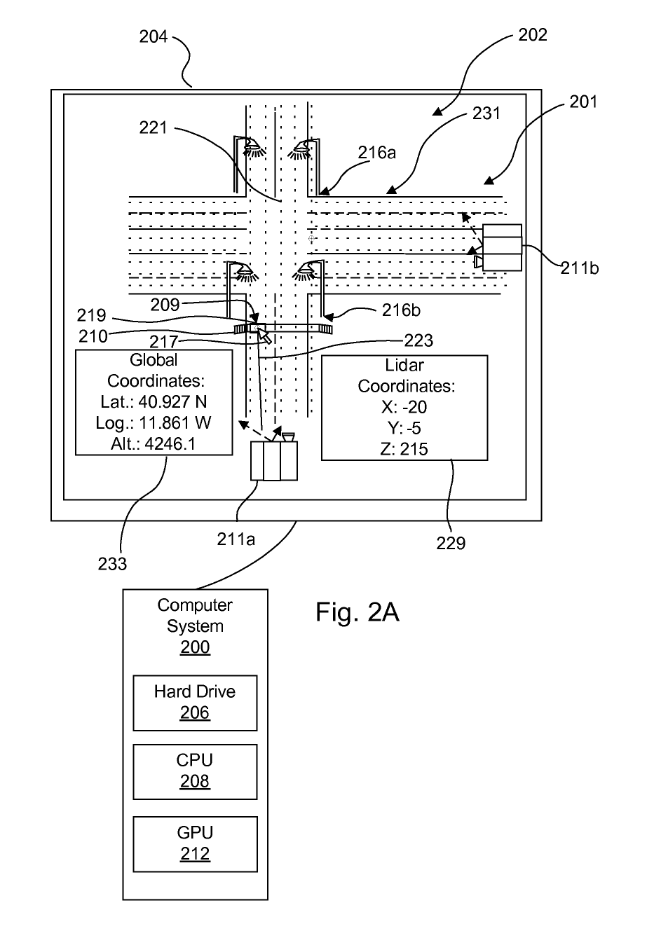

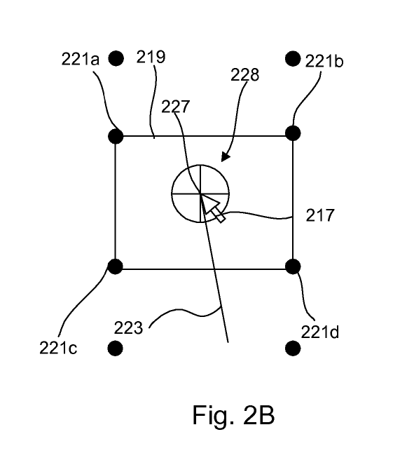

FIG. 2A is a block diagram illustrating a computer system 200 displaying a three-dimensional model 202 of the scene 201. The scene 201 is shown in two-dimensions in FIG. 2A, but is representative of a three-dimensional depiction of the scene 201.

The computer system 200 includes a display device 204 attached thereto, a hard drive 206, central processing unit (CPU) 208, and a graphics processor unit (GPU) 212. The GPU 212 is in electronic communication with the display device 204 and transmits electronic signals that may be converted and displayed as images by the display device 204. For simplicity, certain components of the computer system 200 are not shown, such as a keyboard and mouse. Of course, many different types of computer systems 200 may be used in connection with the disclosed systems and methods.

As indicated above, a three-dimensional model 202 of the scene 201 (which is also illustrated in FIG. 1) is shown on the display device 204. The three-dimensional model 202 includes image data associated or linked with a 3-D spatial data grid 231 (a set of 3-D spatial data points 221) to give the model 202 three-dimensional characteristics. The global or local coordinate data is used to orient and harmonize image and 3-D spatial data gathered from different locations to create the model 202.

FIG. 2B is a close-up view 214 of the model 202 immediately around the painted symbol 209 depicted in FIG. 2A. As indicated above, the painted symbol 209 is obscured by a bridge 210, which prevents the direct gathering of GPS coordinates for the painted symbol 209. However, because the painted symbol 209 is visible in the image data, the global coordinates of the painted symbol 209 may be determined by reference to adjacent 3-D spatial data using the systems and methods disclosed herein.

With reference now to FIGS. 2A and 2B, a mouse pointer 217 on the display device 204 indicates a position on the three-dimensional model 202. The mouse pointer 217 is positioned over an image of the painted symbol 209 to indicate that a user wishes to obtain global coordinates of a point of interest 227 on the painted symbol 209. Of course, other methods may be used to identify a point of interest 227.

In order to obtain global coordinates of a point of interest on a model 202, the model 202 must be properly oriented with respect to a global coordinate system. This orientation process requires that the model 202 be properly positioned with respect to a global coordinate system. Because a three-dimensional space is at issue, this process also requires that the model 202 be positioned at the proper angle or curvature relative to the earth and the global coordinate system utilized. Furthermore, image data, 3-D spatial data, and global or local coordinate data from each of the data gathering devices 211 (an intermediary three-dimensional model) must be harmonized to form a unified and consistent model 202.

To perform these processes (orientation and harmonization of the intermediary three-dimensional models), the global position of two points 216a-b within the scene 201 (in addition to the location of one of the data gathering device 211) must be determined independent of the intermediary three-dimensional models. For example, the global position of each of these points 216a-b may be gathered directly using a GPS or other gathering device. Alternatively, the global position of the points 216a-b may be determined using three-dimensional data regarding the two points 216a-b. This data may then be converted to global positioning data. The two points 216a-b of a known global position together with the known global position of the data gathering device 211 (obtained by the data gathering device 111, which is shown in FIG. 1) comprise three orientation points corresponding to each intermediary three-dimensional model. By aligning each intermediary three-dimensional model with the three orientation points, each intermediary model is correctly positioned within the three-dimensional global space. This alignment, or “registration,” process both harmonizes each of the intermediary models to form a unified and consistent model 202 and also properly orients the resultant model 202 within virtual global coordinates. Fewer orientation points may be utilized when, for example, the orientation and angle of the data gathering device 211 are known. When using three orientation points, the orientation and angle of the data gathering device 211 is not necessary to properly orient the model 202. Also, if three orientation points are positioned within each intermediary model, the global position of the pertinent data gathering device 211 does not need to be known to properly orient that intermediary model relative to a global coordinate system.

Following the orientation and harmonization process, global coordinates of each 3-D spatial data point 221 within the 3-D spatial data grid 231 may be determined by reference to the global location of the data gathering device 211 that gathered the 3-D spatial data point 221 at issue or by reference to points of known global coordinates. As indicated above, GPS data for each data gathering device 211 is obtained by the data gathering devices 211 themselves, potentially (but not necessarily) during or near the scanning process. Once the global coordinates of the data gathering device 211 are known, the global coordinates of 3-D spatial data points 221 within the 3-D spatial data grid 231 may be determined because the 3-D spatial data indicates a three-dimensional distance between the data gathering device 211 and 3-D spatial data points 221 within the grid 231.

To accurately identify the global coordinates of the point of interest 227 between 3-D spatial data points 221 (as illustrated in FIGS. 2A and 2B), in one embodiment, a three-dimensional polygon 219 is formed using 3-D spatial data points 221 proximate the painted symbol 209. A ray trace 223 is directed toward the painted symbol 209 from a designated point of view 225. In this case, the point of view 225 is one of the data gathering devices 211 although other points may be used. An intersection 228 of the three-dimensional polygon 219 and the ray trace 223 at the point of interest 227 is determined using, for example, a ray tracing procedure of an OpenGL library used by the GPU 212 of the computer system 200. The intersection 228 is positioned at and thus identifies the 3-D spatial coordinates 229 of the painted symbol 209 or a point of interest 227 on the painted symbol 209. In one embodiment, the ray trace 223 and the three-dimensional polygon 219 are not shown on the display device 204, i.e., these computations may be performed without a visual representation thereof. In an alternative embodiment, for example, a bilinear interpolation technique rather than a ray tracing algorithm could also be used.

In one embodiment, image data is associated or linked to each 3-D spatial data point 221 to create a three-dimensional model 202 that can be rotated and examined from various angles. Associating the image data with the 3-D spatial data in the model 202 enables a user to more easily and accurately identify a point of interest 227, such as the painted symbol 209.

The foregoing systems and methods may be used to identify the global coordinates 233 of any point of interest 227 within the 3-D spatial data grid 231 and are not limited to determining the global coordinates 233 of points of interest for which global or local coordinate data has directly been gathered. The systems and methods disclosed herein can be used to increase data acquisition efficiency (i.e., fewer 3-D spatial data points are needed) for determining the global or local position of an object or set of objects or a point within a scene captured even if data is gathered from only one location. This system provides significant advantages over conventional systems in that global coordinates may be determined for any point of interest within a previously scanned scene 201 without the need for additional physical inspection or surveying of the scene 201.

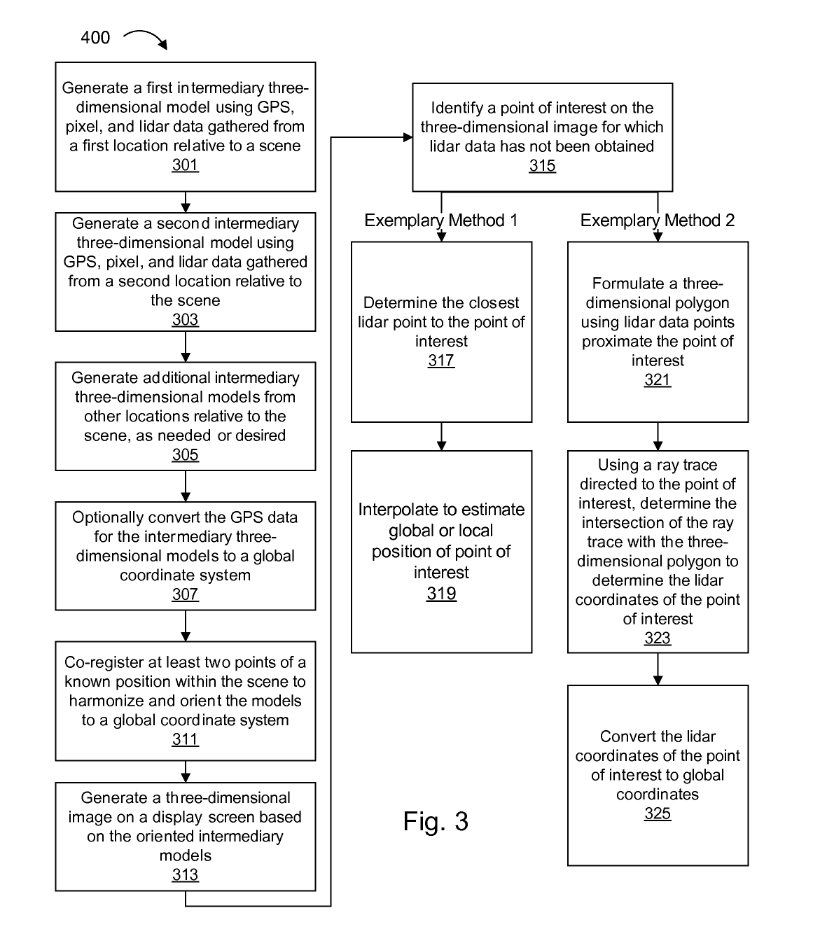

FIG. 3 is a flow diagram 300 illustrating one embodiment of a global position determination method. Using this embodiment of the method, a first intermediary three-dimensional model is generated 301 utilizing GPS, image, and 3-D spatial data gathered from a first location (e.g., a data gathering device 211). An intermediary three-dimensional model, as used herein, is a three-dimensional model generated using GPS (or other global or local coordinate data), image, and 3-D spatial data gathered from a single location rather than from multiple locations. Optionally, a second intermediary three-dimensional model is generated 303 utilizing GPS (or other global or local coordinate data), image, and 3-D spatial data gathered from a second location. In certain embodiments, additional intermediary three-dimensional models are generated 305 based on data gathered from one or more other locations. Each of these intermediary three-dimensional models includes image data associated or linked with a 3-D spatial data grid 231 and associated GPS data (or other global or local coordinate data). In one embodiment, a cluster of pixels (image data) surrounding each 3-D spatial data point 221 is associated with or linked to the pertinent 3-D spatial data point 221. The number of pixels far exceeds the number of 3-D spatial data points 221, in one embodiment, such that the pixels allow for an increased degree of accuracy in selecting specified objects or points of interest within a scene 201. Furthermore, without the image data many objects would not be discernable using only the 3-D spatial data 221 (e.g., paint on a street).

The global or local coordinate data for each of the intermediary three-dimensional models is then optionally converted 307 to a global coordinate system, such as the geographic coordinate system (GCS), which is based on longitude and latitude coordinates. Other global coordinate systems may be used, such as the Universal Transverse Mercator (UTM) coordinate system, the Earth-Centered/Earth-Fixed (ECEF) coordinate system, or the Military Grid Reference System (MGRS), state plane coordinates, or other coordinate systems utilized by in the U.S. and other countries. Conversion of the global or local coordinate data to an alternate global coordinate system may take place at various stages within the scope of the disclosed systems and methods, such as before or concurrent with the generation of an intermediary three-dimensional model.

In an alternative embodiment, GPS data is not utilized in the process. Instead, global or local coordinate data, such as GCS, UTM, ECEF global coordinate data, or state plane or other local coordinate data are gathered directly for the data gathering device(s) 211. Utilizing non-GPS global or local coordinate data, the global or local coordinates of the intermediary three-dimensional models may then be determined without using GPS data, obviating the need for conversion of the GPS data to global or local coordinate system data.

The generated intermediary three-dimensional models are harmonized and oriented 311 to a global or local coordinate system, for example, by registering at least two points of known global or local coordinates in the scene for each model, as explained above. Orienting the intermediary models thus places each 3-D spatial data point 221 and corresponding image data (within each of the intermediary models) in the correct global or local position. This process also harmonizes and blends the intermediary models to form the three-dimensional model 202, an embodiment of which is illustrated in FIG. 2.

Following or concurrent with the orientation process, the three-dimensional image is generated 313 on a display device 204 based on the oriented intermediary three-dimensional models. A point of interest 227 is identified 311 on the three-dimensional model 202 for which no 3-D spatial data has yet been obtained. In the example shown in FIGS. 1 and 2, the painted symbol 109, 209 is such a point or region of interest 227.

Various methods may be used to determine or approximate the global or local coordinates of a point of interest 227. In FIG. 3, a first and a second exemplary method are illustrated. The first exemplary method is illustrated in blocks 317 and 319, while the second exemplary method is illustrated in blocks 321, 323, 325. These examples are illustrative of possible embodiments; however, is not intended to exclude alternate ways. Such implementation decisions should not be interpreted as causing a departure from the scope of the present invention.

With reference to the first exemplary method, the closest 3-D spatial data points 221 to the point of interest 227 are determined 317 using, for example, a triangulation technique. The global or local coordinates of the interpolated 3-D spatial data point are then determined 319, as explained above, to provide an approximation of the global or local coordinates of the point of interest 227. The interpolation technique may be a linear or non-linear three-dimensional technique, a multiple step two-dimensional technique, or other technique.

With reference to the second exemplary method, a three-dimensional polygon 219 (frequently a triangle or rectangle) is formulated 321 in a three-dimensional space using 3-D spatial data points 221 proximate the point of interest. A ray trace 223 is directed to the point of interest 227. The intersection 228 of the three-dimensional polygon 219 and the ray trace 223 is determined 323 using, for example, the GPU and a computer program using the OpenGL library. Thus, the three-dimensional global or local coordinates of the point of interest 227 are determined.

The 3-D spatial coordinates are then converted 325 to global or local coordinates. This conversion may be performed, for example, by determining the global or local coordinates of the origin (e.g., a data gathering device 211), of the 3-D spatial data grid 231 and determining a distance and bearing from the origin to the three-dimensional coordinates of the point of interest 227. Alternatively, as another example, global or local coordinates of another point on the 3-D spatial data grid 231 may be calculated. Thereafter, a distance and a bearing between this point and the point of interest may be determined by calculating differences on the X-, Y-, and Z-axes of the 3-D spatial data grid 231 from this point to the point of interest.

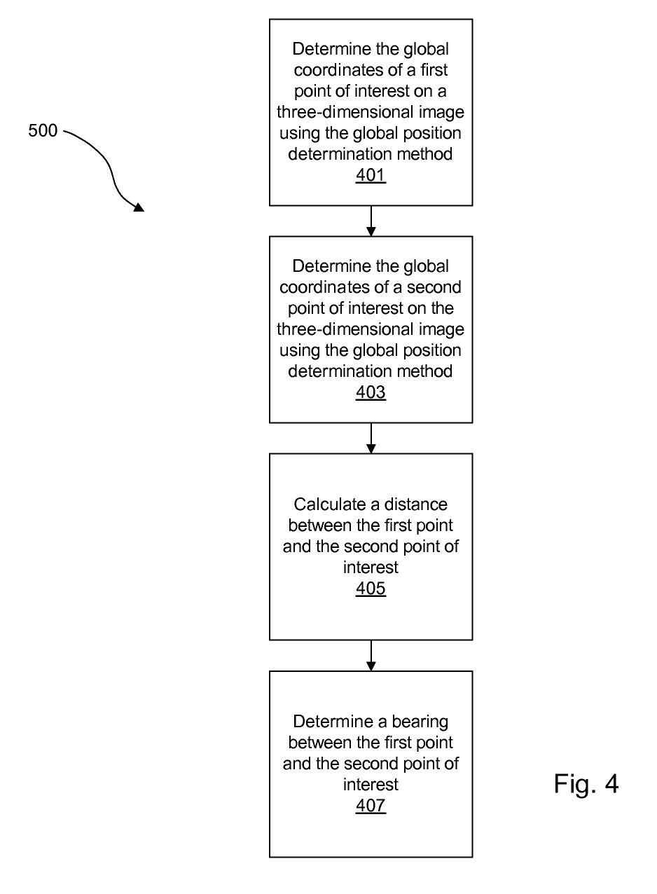

FIG. 4 is a flow diagram 400 illustrating a method for determining a distance and/or bearing between two points of interest 227 on a three-dimensional model 202. The global or local coordinates of a first point of interest 227 on the three-dimensional image are determined 401 using the global or local position determination method, an embodiment of which is disclosed in FIG. 3. The global or local coordinates of a second point of interest 227 are determined 403 using the same method.

A distance between the first and the second point of interest 227 is calculated 405 by determining differences in, for example, latitude, longitude, and elevation. A bearing, or direction, between the points of interest 227 may also be calculated 407 using basic trigonometry. In one embodiment, for example, a distance between a painted symbol 209 and a street light 103 may be determined.

The steps outlined in FIG. 4, may be performed in various ways and in a different order. For example, the location of the first and second point of interest 227 may be identified before any global or local coordinates are determined. After both points of interest 227 are identified, the global or local coordinates of these points may then be determined and relevant distances or angles calculated.

The disclosed systems and methods may be used to perform various important tasks, such as “as-built surveying,” “desktop surveying,” and “survey point generation.” “As-built surveying” refers to the process of using the systems and methods disclosed herein to obtain global or local coordinates for previously existing or previously constructed objects (e.g., building and highways). “Desktop surveying” refers to the process of obtaining global or local coordinates for objects within a scene for which direct global or local position data was not previously obtained or determined—without the need to revisit the scene and gather such data to obtain the global or local coordinates. “Survey point generation” refers to the process of identifying the global or local coordinates of a specific point within a scene for which global or local data was not gathered likewise, without the need to revisit the scene.

As used herein, the term “global coordinate” or “global position data” refers to any type of data indicating the global position of a point, object, or region. Likewise, the term “local coordinate,” “field-specific coordinate,” or “local position” refers to any type of data indicating the local position of a point, object or region. Global coordinate data may be derived, for example, from GPS data or data obtained using a total station system, or may be, for example, GPS, GCS, UTM, or ECEF data. It should also be noted that disclosed systems and methods could be utilized to determine the position of a point, object, or region within a local or field-specific coordinate system. Thus, the terms “Global Position,” “Global Coordinates,” “Global Positioning System” and “GPS Signals” and related terms could also include local or field-specific coordinates or coordinate systems, such state plane coordinate system, or other. To be more specific, the position of each of the data gathering device(s) 211 could be determined relative to a local or field-specific coordinate system. The 3-D spatial data and image data gathered by each data gathering device(s) could then be oriented relative to the local or field-specific coordinate system to align the 3-D spatial data and image data. Thereafter, positions of points within the aligned 3-D spatial and image data may be optionally determined relative to the local or field-specific coordinate system. Also, in certain circumstances, the local or field-specific coordinates are adequate and global coordinates of any kind are not needed. In yet another embodiment, global coordinates of positions may be determined, using the systems and methods explained above. Thereafter, the global coordinates may be converted to a local or field-specific coordinate system based on the determined or known position of the local or field-specific coordinate system relative to the global coordinate system in use.

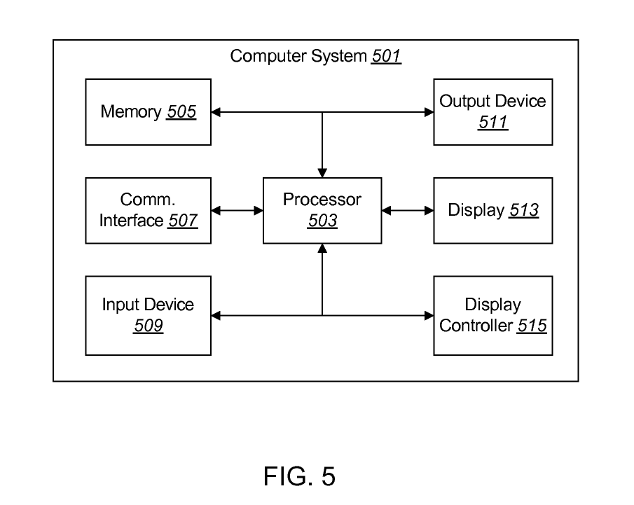

FIG. 5 is a block diagram illustrating the major hardware components typically utilized in a computer system 501. A computer system 501 may be utilized to perform, for example, many computations and calculations discussed herein. The illustrated components may be located within the same physical structure or in separate housings or structures.

The computer system 501 includes a processor 503 and memory 505. The processor 503 controls the operation of the computer system 501 and may be embodied as a microprocessor, a microcontroller, a digital signal processor (DSP) or other device known in the art. The processor 503 typically performs logical and arithmetic operations based on program instructions stored within the memory 505.

As used herein, the term memory 505 is broadly defined as any electronic component capable of storing electronic information, and may be embodied as read only memory (ROM), random access memory (RAM), magnetic disk storage media, optical storage media, flash memory devices in RAM, on-board memory included with the processor 503, EPROM memory, EEPROM memory, registers, etc. The memory 505 typically stores program instructions and other types of data. The program instructions may be executed by the processor 503 to implement some or all of the methods disclosed herein.

The computer system 501 typically also includes one or more communication interfaces 507 for communicating with other electronic devices. The communication interfaces 507 may be based on wired communication technology, wireless communication technology, or both. Examples of different types of communication interfaces 507 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 501 typically also includes one or more input devices 509 and one or more output devices 511. Examples of different kinds of input devices 509 include a keyboard, mouse, microphone, remote control device, button, joystick, trackball, touchpad, lightpen, etc. Examples of different kinds of output devices 511 include a speaker, printer, etc. One specific type of output device which is typically included in a computer system is a display device 513. Display devices 513 used with embodiments disclosed herein may utilize any suitable image projection technology, such as a cathode ray tube (CRT), liquid crystal display (LCD), light-emitting diode (LED), gas plasma, electroluminescence, or the like. A display controller 515 may also be provided, for converting data stored in the memory 505 into text, graphics, and/or moving images (as appropriate) shown on the display device 513.

Of course, FIG. 5 illustrates only one possible configuration of a computer system 501. Various other architectures and components may be utilized. The computer system 501 could be embodied, by way of example only, as a desktop or laptop computer system or as an embedded computing device working connection with a LIDAR or other 3-D spatial data scanner, GPS receiver, and/or imaging device (e.g., a digital camera).

Information and signals, referred to in this application, may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for determining a global or local position of a point of interest using a three-dimensional model, comprising:
generating a three-dimensional model using global or local coordinate data, 3-D spatial data, and image data gathered from one or more locations for a scene;
identifying a point of interest on the three-dimensional model for which 3-D spatial data has not been obtained;
formulating a three-dimensional polygon using 3-D spatial data points proximate the point of interest;
determining 3-D spatial coordinates of the point of interest using the formulated three-dimensional polygon and a ray tracing or other interpolation technique; and
converting the 3-D spatial coordinates of the point of interest to global or local coordinates.

2. The method of claim 1, wherein global or local coordinate data, 3-D spatial data, and image data for the model are gathered from multiple locations for the scene.

3. The method of claim 1, wherein the 3-D spatial data comprises data indicating a distance from a data gathering device to points within the scene.

4. The method of claim 1, wherein the image data is gathered by a digital camera.

5. The method of claim 1, wherein the point of interest is obstructed such that GPS data cannot be gathered directly for the point of interest.

6. A system for determining a global or local position of a point of interest using a three-dimensional model, the system comprising:
a processor;
memory in electronic communication with the processor; and
instructions stored in the memory, the instructions being executable to:
generate a three-dimensional model using global or local coordinate data, 3-D spatial data, and image data gathered from one or more locations for a scene;
identify a point of interest on the three-dimensional model for which 3-D spatial data has not been obtained;
formulate a three-dimensional polygon using 3-D spatial data points proximate the point of interest;
determine 3-D spatial coordinates of the point of interest using the formulated three-dimensional polygon and a ray tracing or other interpolation technique; and
convert the 3-D spatial coordinates of the point of interest to global or local coordinates.

7. The system of claim 6, wherein global or local coordinate data, 3-D spatial data, and image data for the model are gathered from multiple locations for the scene.

8. The system of claim 6, wherein the 3-D spatial data comprises data indicating a distance from a data gathering device to points within the scene.

9. The system of claim 6, wherein the image data is gathered by a digital camera.

10. The system of claim 6, wherein the point of interest is obstructed such that GPS data cannot be gathered directly for the point of interest.

11. A computer-readable medium comprising executable instructions for determining a global or local position of a point of interest using a three-dimensional model, the instructions being executable to:
generate a three-dimensional model using global or local coordinate data, 3-D spatial data, and image data gathered from one or more locations for a scene;
identify a point of interest on the three-dimensional model for which 3-D spatial data has not been obtained;
formulate a three-dimensional polygon using 3-D spatial data points proximate the point of interest;
determine 3-D spatial coordinates of the point of interest using the formulated three-dimensional polygon and a ray tracing or other interpolation technique; and
convert the 3-D spatial coordinates of the point of interest to global or local coordinates.

12. The computer-readable medium of claim 11, wherein global or local coordinate data, 3-D spatial data, and image data for the model are gathered from multiple locations for the scene.

13. The computer-readable medium of claim 11, wherein the 3-D spatial data comprises data indicating a distance from a data gathering device to points within the scene.

14. The computer-readable medium of claim 11, wherein the image data is gathered by a digital camera.

15. The computer-readable medium of claim 1 1, wherein the point of interest is obstructed such that GPS data cannot be gathered directly for the point of interest.
